(19) United States
(12) Patent Application Publication
(10) Pub. No.: US 2021/0165382 A1
(43) Pub. Date: Jun. 3, 2021

(54) AUTOMATION FIELD DEVICE

(71) Applicant: Endress+Hauser Process Solutions AG, Reinach (CH)

(72) Inventors: Michael Mayer, Oberwil (CH); Andreas Büchin, Lörrach (DE); Norbert Cornelsen, Wieslet (DE)

(21) Appl. No.: 17/267,098

(22) PCT Filed: Jul. 30, 2019
(86) PCT No.: PCT/EP2019/070485

§ 371 Date: Feb. 9, 2021

(30) Foreign Application Priority Data
Aug. 9, 2018 (DE) 10 2018 119 411.0

(51) Int. Cl. G05B 19/042

(52) U.S. Cl. CPC G05B 19/0425; G05B 2219/25428; G05B 19/0426

(57) ABSTRACT

Disclosed is an automation field device, comprising a sensor unit for registering a physical, measured variable of a medium; a first communication interface for connecting to a first communication network; a second communication interface for connecting to a second communication network; a first electronics unit embodied to convert the physical, measured variable registered by the sensor unit into a measured value, to provide the measured value via the first communication interface to the first communication network and to generate diagnostic- and/or maintenance information; a transmitting unit contained in the first electronics unit and embodied to transmit the diagnostic- and/or maintenance information generated by the first electronics unit; a second electronics unit including a receiving unit embodied to receive the diagnostic- and/or maintenance information transmitted by the transmitting unit embodied to provide the diagnostic- and/or maintenance information via the second communication interface to the second communication network.

The invention relates to an automation field device.

Known in the state of the art are field devices, which are used in automation of industrial plants. Thus, field devices are often applied in process automation, as well as in manufacturing automation. Referred to as field devices are, in principle, all devices, which are applied near to a process and which deliver, or process, process relevant information. Field devices are used for registering and/or influencing process variables. Serving for registering process variables are sensor units. Such are used, for example, for pressure- and temperature measurement, conductivity measurement, flow measurement, pH measurement, fill level measurement, etc. and register the corresponding process variables, pressure, temperature, conductivity, pH value, fill level, flow, etc. Used for influencing process variables are actuator systems. Such are, for example, pumps or valves, which can influence the flow of a liquid in a tube or the fill level in a container. Besides the above mentioned measurement devices and actuators, referred to as field devices are also remote I/Os, radio adapters, and, in general, devices, which are arranged at the field level.

In modern industrial plants, field devices are, as a rule, connected with superordinated units via communication networks, such as, for example, fieldbuses (Profibus®, Foundation® Fieldbus, HART®, etc.). The superordinated units are control units, such as, for example, a PLC (programmable logic controller). The superordinated units serve, among other things, for process control, as well as for commissioning of field devices. The measured values registered by field devices, especially sensor units, are transmitted via the particular bus system to one or more superordinated unit(s), which, in given cases, process the measured values further and forward them to the control station of the plant. The control station serves for process visualizing, process monitoring and process control via the superordinated units. In addition, also a data transmission from a superordinated unit via the bus system to the field devices is required, especially for configuration and parametering of field devices as well as for operation of actuators, in the case of which a write access occurs in the field device.

By means of the fieldbus protocols in the present state of the art, other information, besides actual measured values, is queryable from field devices. This information can be, for example, diagnostic information and/or maintenance information. In these fieldbus protocols, the retrieval of such so-called “read-only information”, for which no write access in the field device is present, rests on a query-response approach: the superordinated unit, or a service unit, sends a query telegram to the field device. The field device transmits then an answer protocol with the requested information to the superordinated unit, or to the service unit. Alternatively, the requested information is published in regular time intervals by the field device (for example, in the so-called “burst” mode of the HART protocol).

A danger in the case of application of fieldbuses, especially when these are connected with the Internet, is that unauthorized persons gain access to the field devices, or their sensitive data, such as, for example, their parameter sets, via query telegrams. Often, consequently, for critical infrastructure, it is not desired to connect these fieldbuses to the Internet, since the described risks, as a rule, outweigh the benefits.

Based on the above, an object of the invention is to provide a method, which an enables increased safety in the case of application of a field device in a network environment.

The object is achieved by an automation field device comprising:
a sensor unit for registering a physical, measured variable of a medium;
a first communication interface for connecting to a first communication network;
a second communication interface for connecting to a second communication network;
a first electronics unit, wherein the first electronics unit is embodied to convert the physical, measured variable registered by the sensor unit into a measured value, to provide the measured value via the first communication interface to the first communication network and to generate diagnostic- and/or maintenance information;
a transmitting unit, which is contained in the first electronics unit and which is embodied to transmit the diagnostic- and/or maintenance information generated by the first electronics unit;
a second electronics unit, wherein the second electronics unit includes a receiving unit, wherein the receiving unit is embodied to receive the diagnostic- and/or maintenance information transmitted by the transmitting unit, and wherein the second electronics unit is embodied to provide the diagnostic- and/or maintenance information via the second communication interface to the second communication network.

According to the invention, the measured values and additional information in the form of diagnostic- and/or maintenance information obtained by the field device are output via different communication interfaces. The field device electronics is, in such case, embodied in such a manner that only the additional information can be read-out via the second communication interface. An accessing of the first electronics unit via the second communication interface is not possible. Besides the described functions, the first electronics unit serves for control of the functions of the field device and for parameter administration of the field device. An accessing of the first electronics unit could enable an unauthorized person to gain insight into sensitive data of a field device, for example, its parameter settings.

Supplemental information of the field device is transmitted unidirectionally from the first electronics unit to the second electronics unit, since the transmitting unit can only transmit information, however, not receive information, wherein the receiving unit information can only receive and not transmit. A transmission back from the second electronics unit to the first electronics unit is, thus, not possible.

The first and second electronics units are electronic circuits, which are implemented, for example, in analog manner on a circuit board, in a microcontroller or in an ASIC.

Applications of such a field device of the invention are named above, by way of example, in the introductory portion of the description.

In a first variant of the field device of the invention, it is provided that the transmitting unit is an acoustic output source, especially a loudspeaker, which is embodied to transmit the diagnostic- and/or maintenance information by means of modulated sound waves. The information is transmitted, in such case, for example, by means of amplitude- and/or frequency modulation. Also frequency shift keying modulation, multifrequency coding or pulse code modulation can be used.

In an embodiment of the first variant of the field device of the invention, it is provided that the receiving unit is an acoustic receiving source, especially a microphone, which is embodied to receive the received waves transmitted from the transmitting unit, to demodulate them and to provide them to the second electronics unit.

In a second variant of the field device of the invention, it is provided that the transmitting unit is an electromagnetic output source, especially a light source, which is embodied to transmit the diagnostic- and/or maintenance information by means of modulated electromagnetic radiation. The information is transmitted, in such case, for example, amplitude modulated or preferably frequency modulated. The transmitting unit is, for example, a light emitting diode, which transmits electromagnetic radiation in the visible wavelength range or in the infrared- and UV region.

In an embodiment of the second variant of the field device of the invention, it is provided that the receiving unit is an electromagnetic receiving source, especially a light sensor, which is embodied to receive the electromagnetic radiation transmitted by the transmitting unit, to demodulate it and to provide it to the second electronics unit. The light source is an apparatus, which converts light using the external or the internal photoelectric effect into an electrical signal or has an electrical resistance dependent on the incoming radiation. The term light includes not only visible light but also infrared light and ultraviolet radiation invisible to the human eye. Examples of light sensors, which utilize the external photoelectric effect are photocells and photomultipliers. Examples of light sensors, which utilize the internal photoelectric effect are CMOS sensors, CCD sensors, photodiodes and phototransistors.

Other alternative embodiments provide other options. For example, used as transmitting unit can be a radiation source, which emits radioactive radiation, thus for example alpha/beta-, or gamma radiation, or x-ray radiation. Information can be transmitted, for example, by modulating the radiation by means of a displaceable diaphragm by opening and closing the diaphragm. Serving as receiving unit can be a radiation detector or a dosimeter, or scintillation counter.

In an additional variant, the transmitting unit is a mechanical component, for example, a bar, which is driven by a magnet, for example. Serving as receiving unit is, for example, a contact detecting element, for example, a pressure sensor. The information is especially digitally transmitted: If within a fixed time interval a contact of the bar on the contact detecting element is detected, such corresponds to a logical “1”. If within the time interval no contact is detected, such corresponds to a logical “0”.

An advantageous embodiment of the field device of the invention provides that the first communication interface is an interface for connecting to an electrical current loop. The first communication network is, thus, an electrical current loop, which preferably works according to 4-20 mA technology. The measured values are transmitted, thus, purely as analog values. Even when the communication network of the plant has connection to the Internet, an unknown person could not access the field device via the analog electrical current loop and request its sensitive information.

An advantageous embodiment of the field device of the invention provides that the second communication interface is an interface for connecting to an automation fieldbus. The second communication network is, thus, a fieldbus, which, for example, is based on one of the protocols, HART, Profibus PA/DP, Foundation Fieldbus, etc. The additional information can be digitally queried via this fieldbus. In the case, in which the fieldbus is connected with the Internet and an unauthorized person obtains access to the second electronics unit, such person could not access sensitive data of the field device created, processed, or managed by the first electronics unit.

The invention will now be explained in greater detail based on the appended drawing, the sole FIGURE of which shows as follows:

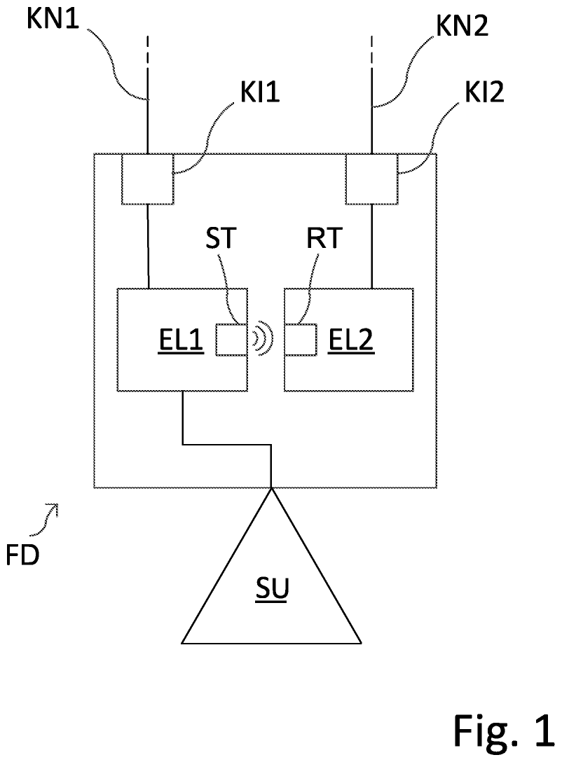

FIG. 1 a first example of an embodiment of the field device of the invention.

FIG. 1 shows a field device FD of the invention. The field device FD is installed at a measuring point of an automated plant and serves for determining a physical, measured variable of a process medium. For registering the physical, measured variable, the field device FD includes a sensor unit SU. For example, the sensor unit SU is a radar unit and serves for the contactless measuring of a fill level of a medium in a container. Other examples of such sensor units SU and possible applications for the field device FD have already been listed, by way of example, in the introductory portion of the description.

For transforming/further processing of the registered measured variable and for controlling the measuring process, the field device FD includes a first electronics unit EL1, for example, in the form of a microcontroller or an ASIC. The registered measured variable is processed by the first electronics unit EL1 into a measured value and provided to a first communication interface KI1. A first communication network KN1 is connected to the first communication interface KI1. The first communication network is an electrical current loop, which uses 4-20 mA technology. As a function of size of the measured value, analogously an electrical current value between 4 mA and 20 mA is output via the electrical current loop. Since the electrical current loop works purely in an analog manner, the field device cannot be serviced via the first communication interface KI1. A hacking of the field device FD via connecting of an unauthorized person with the first communication network KN1 is, consequently, not possible.

Besides the above described functions, the first electronics unit EU serves for control of the functions of the field device FD, for parameter administration of the field device FD and for creating diagnostic- and/or maintenance information of the field device FD. The diagnostic- and/or maintenance information (“function in order”, “maintenance required”, “case of malfunction”, etc.) is created, for example, according to the NAMUR recommendation and represents the device status of the field device FD.

This diagnostic- and/maintenance information is not transmittable via the first communication network KN1, since this is embodied only for analog transmission of the measured values of the field device FD. For digital transmission of the diagnostic- and/or maintenance information, the field device FD includes a second communication interface KI2. This second communication interface KI2 is embodied for connecting to an automation fieldbus, which enables a digital transmission of information. Such a fieldbus is based on one of the established protocols, for example, one of the protocols, HART, Profibus PA/DP, Foundation Fieldbus, etc.

A direct connection of the first electronics unit EL1 with the second communication interface KI2 introduces the risk that an unauthorized person could obtain access to sensitive information of the field device FD, for example, by means of triggering a buffer overflow in the communication stack of the field device FD, especially when the second communication network KN2 is connected with the Internet.

In view of this, the second communication interface KI2 is not directly connected with the first electronics unit EL1. The field device FD is embodied in such a manner that it has a second electronics unit EL2, which is connected with the second communication interface KI2. The second electronics unit serves for control of the second communication interface KI2 and for transmission of the information to be transmitted from the second communication interface.

The transmission of the diagnostic- and/or maintenance information from the first electronics unit EL1 to the second electronics unit EL2 occurs by means of a unidirectional transmission path. To this end, the first electronics unit EL1 includes a transmitting unit ST and the second electronics unit EL2 includes a receiving unit RT.

The transmitting unit ST is, for example, a loudspeaker, which transmits the diagnostic- and/or maintenance information by means of frequency modulated sound waves. The second electronics unit EL2 receives the diagnostic- and/or maintenance information by means of a microphone and provides the diagnostic- and/or maintenance information to the second communication interface KI2.

Alternatively, it is provided that the transmitting unit is a light emitting diode, which transmits the diagnostic- and/or maintenance information by means of frequency- and/or phase modulated, electromagnetic radiation. The second electronics unit EL2 receives the diagnostic- and/or maintenance information by means of a light sensor and provides the diagnostic- and/or maintenance information to the second communication interface KI2.

In this way, an exclusively unidirectional data transmission from the first electronics unit EL1 to the second electronics unit EL2 is enabled. Even when an unauthorized person would obtain access via the second communication network KN2 to the second electronics unit, the person could not obtain access to the sensitive data of the field device FD administered by the first electronics unit EL1.

The example of an embodiment shown in FIG. 1 is purely by way of example. The invention includes other possible combinations of type of field device, types of first and second communication networks KN1, KN2 and types of receiving- and transmitting units ST, RT.

### LIST OF REFERENCE CHARACTERS

RT receiving unit
FD field device
SU sensor unit
EL1, EL2 electronic units
KN1, KN2 communication networks
KI1, KI2 communication interfaces
ST transmitting unit

1-7. (canceled)

8. An automation field device, comprising:
a sensor unit for registering a physical, measured variable of a medium;
a first communication interface for connecting to a first communication network;
a second communication interface for connecting to a second communication network;
a first electronics unit embodied to convert the physical, measured variable registered by the sensor unit into a measured value, to provide the measured value via the first communication interface to the first communication network, and to generate diagnostic- and/or maintenance information;
a transmitting unit contained in the first electronics unit and embodied to transmit the diagnostic- and/or maintenance information generated by the first electronics unit;
a second electronics unit including a receiving unit embodied to receive the diagnostic- and/or maintenance information transmitted by the transmitting unit and further embodied to provide the diagnostic- and/or maintenance information via the second communication interface to the second communication network.

9. The field device as claimed in claim 8, wherein the transmitting unit is an acoustic output source embodied to transmit the diagnostic- and/or maintenance information via modulated sound waves.

10. The field device as claimed in claim 9, wherein the receiving unit is an acoustic receiving source embodied to receive the sound waves transmitted by the transmitting unit, to demodulate the received sound waves, and to provide the demodulated, received sound waves to the second electronics unit.

11. The field device as claimed in claim 8, wherein the transmitting unit is a light source embodied to transmit the diagnostic- and/or maintenance information via modulated electromagnetic radiation.

12. The field device as claimed in claim 11, wherein the receiving unit is a light sensor embodied to receive the electromagnetic radiation transmitted by the transmitting unit, to demodulate the received electromagnetic radiation, and to provide the demodulated, received electromagnetic radiation to the second electronics unit.

13. The field device as claimed in claim 8, wherein the first communication interface is an interface for connecting to an electrical current loop or to a HART-modulated electrical current loop.

14. The field device as claimed in claim 8, wherein the second communication interface is an interface for connecting to an automation fieldbus.
